(19) United States
(12) Patent Application Publication
(10) Pub. No.: US 2004/0163484 A1
(43) Pub. Date: Aug. 26, 2004

(54) Modular unit of a gear-shifting mechanism and method for producing the modular unit

(76) Inventors: Waldemar Maier, Herzogenaurach (DE); Roland Kern, Herzogenaurach (DE); Gunter Rost, Lonnerstadt (DE); Kurt Besenbeck, Herzogenaurach (DE)

Correspondence Address: OSTROLENK FABER GERB & SOFFEN, 1180 AVENUE OF THE AMERICAS, NEW YORK, NY, 100368403

(21) Appl. No.: 10/787,686

(22) Filed: Feb. 25, 2004

(30) Foreign Application Priority Data
Feb. 25, 2002 (DE) 103 07 881.9

(51) Int. Cl. B60K 20/00

(52) U.S. Cl. 74/473.36

(57) ABSTRACT

A modular unit of a gear-shifting mechanism with individual assembled together components including a machine part and a support therefor, which are rotatable relatively. The unit is subjected after the assembly of the components to a complete heat treatment and optionally subsequently to a coating. The heat treatment may be thermochemical or nitriding and the coating layer may be iron oxide.

### FIELD OF THE INVENTION

The invention relates to a modular unit of a gear-shifting mechanism and to a method for producing it. The modular unit is prefabricated independently of the gear-shifting unit. This modular unit has at least one machine part made of an iron material and at least one support made of an iron material, which supports the machine part. They are brought together in the modular unit, and the machine part being connected to the support in such a way that it is at least pivotable about an axis of rotation in relation to the support.

### BACKGROUND OF THE INVENTION

Modular units of this type are used, for example, in gear-shifting or selector shaft units in transmissions of automobiles and bicycles. The invention also relates to further modular units in which transmission elements that are movable in relation to one another and are fastened to one another and are pre-assembled to form the modular unit before their installation in the vehicle transmission. These modular units have at least one support, which is formed for example as a lever which is pivotable in relation to the transmission. The support receives a machine part in the form of a roller which is fastened in a rotationally movable manner to the lever or in the form of a second lever fastened in a pivotable manner to the first lever. The rotating or pivoting connection between the individual parts of the modular unit that are rotationally or pivotably movable and fastened to one another is formed for example by a pivot pin on one of the individual parts of the modular unit or by a separate pivot bolt. The pivotable machine part is then seated on the pivot bolt or pivot pin, for example, with a clearance fit.

A modular unit of this type in the form of a selector arm is described in DE 40 20 160 A1. The selector arm is formed by a lever-like support of a roller and a bolt and is seated in the transmission in a rotationally fixed manner on a gear-shifting shaft. In this case, the roller is rotatably mounted on the bolt firmly fixed to the support.

In the production of vehicle transmissions, there is an increasing trend toward the practice of not installing the components of the transmission individually into the transmission but instead of putting a number of components together as pre-assembled modular units. The advantages of the use of modular units are obvious. The logistical expenditure for storage and delivery of the transmission components and the assembly times of transmissions are reduced. Instances of incorrect assembly are avoided. Due to their different function in the modular unit and due to the use of different methods in their production, the components are often produced from different iron or steel materials. The individual parts of such modular units according to the prior art are subjected to heat treatments and coating methods that differ from component to component before they are assembled to form the modular unit. As a result, a person skilled in the art only has a limited selection of connecting techniques available for connecting the components to form the modular unit. For example, hardened components can scarcely be welded or cannot be welded. Since welding is a low cost joining method, in particular in large series and mass production, hardening of the individual parts is often initially dispensed with before assembly. After the assembly of modular subunits or after the connecting of the components to form the modular unit, the stressed points are often partially hardened, for example by induction. Such expensive treatments at least partly negate the cost advantage that is obtained by using modular units for assembly in the transmission. Parts hardened before being connected to form the modular unit are often provided with an allowance, for example in the region of the rotatable connection, to be able to compensate for the defects caused by hardening distortion or geometrical change during hardening by subsequent machining work. The subsequent machining work is a further factor that increases cost and is therefore disadvantageous. Subsequent work on the parts is often dispensed with. The hardening distortion and the geometric changes caused by the hardening are then taken into account by corresponding allowances in the magnitude of the heat distortion and the changes in volume when the parts are designed, in particular at the pivoting or rotating seating. In this case, excessively large or small amounts of play in the pivoting or rotating connection of the components in the modular unit are to be expected, since such hardening distortions and geometric changes cannot be predicted reliably in terms of the processes involved. The allowances also have to be taken into account in the size of the layer thicknesses to be expected on components that are coated before their assembly to form the modular unit, so that, in this case too, excessively large or small amounts of play in the pivoting or rotating seating are to be expected.

### SUMMARY OF THE INVENTION

The object of the invention is therefore to provide a modular unit of the generic type in the assembly of which the aforementioned disadvantages are avoided.

This object is achieved according to the invention by the modular unit having at least partly a hard outer layer produced by a heat treatment of the complete module. Consequently, the invention provides a method for producing a modular unit of this type in which the individual parts comprising the support and machine part are first produced individually and are then connected to one another in the soft, untreated state. After the assembly of the components to form the modular unit, the heat treatment follows and, as provided in a refinement of the invention, a coating is applied.

A modular unit according to the invention may have a number of the supports, to which one or more of the machine parts are respectively fastened. As an alternative to this, the modular unit may be provided with one support, to which a number of the machine parts are fastened in a pivotable or rotatable manner. Since the individual components are supplied to the modular unit in a not hardened (soft) form, welding and caulking can also be used for connecting the components.

The modular unit comprising at least the support and machine part as components and also preferably comprising a bolt is subjected to a heat treatment either after the assembly of the individual parts or else after the assembly of submodules comprising the aforementioned individual parts. Heat treatment is to be understood in this case as meaning all treatments in which the module is exposed in a time sequence to temperatures and, if appropriate, additionally to other physical and/or chemical effects. These effects, optionally on their own or in combination with one another, increase the hardness, the wear resistance and the corrosion resistance of at least large regions of the surface of the individual parts of the module. In this case, the thermochemical treatments, in which primarily the properties of the outer layer of the material are changed, such as case hardening or nitriding or nitrocarburizing, are to be given preference over the methods in which the state of the material is deliberately changed in the entire cross section of the workpieces, such as in the case of full hardening. In the case of thermochemical treatment, apart from a few exceptions, the form of the individual parts is preserved without any significant hardening distortion (little distortion of the components) on account of the relatively low temperatures to which the module is exposed during and up to completion of the heat treatment.

Case hardening, as one of the exceptions of thermochemical treatment, and full hardening are heat treatments which, due to their high temperatures, generally inevitably produce distortion on a workpiece. Subsequent work at the points that are critical for the module, in particular at the seating of the pivotable machine part on a bolt or pin, is not possible and also not desired because of high costs. The heat distortion must therefore be taken into account in the allowance tolerances mentioned at the beginning, so that an amount of play that does not adversely influence the function is set in the seating after hardening.

Preferred thermochemical methods for the treatment of a module according to the subject matter of the invention are nitriding methods. In these, optionally either the known nitriding with diffusion of nitrogen, such as for example gas nitriding and plasma nitriding, or the nitriding similarly known to those skilled in the art with diffusion of nitrogen and carbon, such as gas nitrocarburizing and plasma nitrocarburizing, are provided. The components are exposed to lower temperatures during such treatments in comparison with hardening. Given the same surface hardness, the nitriding depth is less in comparison with the hardening depth in case hardening, since the surface stresses on nitrided components are greater.

Both the low temperatures typical of the methods and the low nitriding depth have the effect that the individual parts and the modules suffer hardly any heat distortion. The invention dispenses with allowance tolerances in the production of the individual parts, in particular at the pivoting or rotating seating of the machine part on the bolt. These previously had to be taken into account in the production of the individual parts due to the expected heat distortion of the parts to be joined to one another and the magnitude of that distortion is difficult to estimate in advance. With the invention, allowances are no longer provided on the individual parts for subsequent working of the hardening distortion.

The only changes to be taken into account are the increase in volume of the included amount of nitrogen, dependent on the material of the component. Since the volume of the treated part increases, in the case of a bolt made of a low-alloy steel for example for a nitriding depth of 0.4 to 0.6 μm by 15-20 μm, the increase in volume can be used for specifically setting the amount of play in the rotating or pivoting seating of the machine part on the bolt, in particular in the case of nitriding in gas and plasma. The amount of play required for example for simple assembly of a roller on a bolt, between the bore of the roller and the outside diameter of the bolt, can be advantageously reduced by the heat treatment. It has been possible to demonstrate by measurements on modular units completely hardened according to the invention that, independently of the duration of the nitriding operation, the increase in volume within the gap between the bolt and a rotatable machine part (roller) at the elements paired with one another only continues until there is no longer sufficient atmosphere of gas or plasma at this point in the annular gap. The bonding of nitrogen is consequently ended in the annular gap of the rotating seating, independently of the nitriding operation continuing on the modular unit. An advantageous small amount of play for a pivoting or rotating connection that functions well is set.

The strength and wear resistance at the surface of the components is increased by means of the nitriding method. The surface of the treated material has improved sliding properties. This is advantageous in particular for the rotating connection between the machine part, preferably a roller, and the bolt, and for the sliding-rolling contact between the running surface of the roller and a transmission part that is acted on by the roller. A further advantage lies in the cost reduction brought about by eliminating the operations such as adjusting the components of the modular unit to the functional dimensions and eliminating undesired process-induced residues on the surface, primarily in holes, or the like of the module.

Selection of the nitriding methods depends on various factors and is to be decided in the individual case. A preferred refinement of the invention provides plasma nitriding. As an alternative, however, gas nitriding is also provided. Nitriding is suitable for the treatment of all customary iron-based materials, steel and cast iron and also sintering materials, since these can virtually all be gas-nitrided and can all be plasma-nitrided. This is particularly advantageous, since cold-workable low-carbon steels are often used for the individual parts of the modules according to the subject matter of the invention. It is virtually impossible for these materials of the preferably drawn, extruded or stamped parts for the module according to the invention to be hardened without carburizing of the outer layers by the case hardening methods mentioned at the beginning and the associated disadvantages of heat distortion. Nitriding makes it possible for these materials also to be provided with a hard outer layer. The individual parts of the module made of low-carbon weldable steels are often fastened to one another by welding, such as a bolt to the support. The welding is possible without any problem, since the parts are welded before the heat treatment and before a coating following the heat treatment. In addition, it is advantageous that, in plasma nitriding, surfaces on the modules that are not to be treated can be covered in an uncomplicated way by applying a copper paste or thread to the individual parts of the modules, for example by screwing in screws or screwing on nuts.

The corrosion behavior of nitrided surfaces, in particular on unalloyed and low-alloy steels, is improved by the bonding layer formed from stable nitrides. The corrosion resistance is further improved by use of known post-oxidizing as a component part of the nitriding treatment or oxidizing after the nitriding treatment. Oxidizing is a method that is used particularly in large-series and mass production of the automobile industry for improving corrosion resistance. Such a layer is particularly advantageous if the modules at least partly protrude into the open, as in the case of motorcycles or gearshift domes on transmissions. Post-oxidizing and oxidizing is a thermochemical method for influencing the exterior outer layer. The entire outer layer is made up of three zones after the post-oxidizing of the nitride layer. The first zone is a diffusion layer, which forms the transition to the base material and supports the composite of layers lying above it. The first zone is followed in the outward direction, away from the base material, by a hard and wear-resistant bonding layer, which generally has a layer thickness of 15-30 μm. The surface has a third zone in the form of a thin oxide layer (for example 1-3 μm thick) of Fe₃O₄. Since the individual parts according to the invention are connected to one another to form a module before the heat treatment, after the heat treatment even welds and outbreaks of material from connections provided by joining and caulking are provided with a corrosion-resistant outer layer, which is optionally additionally corrosion-stabilized by the oxidizing. The invention avoids need for allowance tolerances in the production of the individual parts, in particular at the pivoting or rotating seating of the machine part on the bolt, which previously had to be taken into account because of the coatings applied to the parts before the assembly of the parts.

Other features and advantages of the present invention will become apparent from the following description of the invention which refers to the accompanying drawings.

### BRIEF DESCRIPTION OF THE DRAWINGS

FIG. 1 shows an exemplary embodiment of the modular unit 1 configured as a selector shaft unit 6.

FIGS. 2 to 4 show individual parts of the modular unit 1.

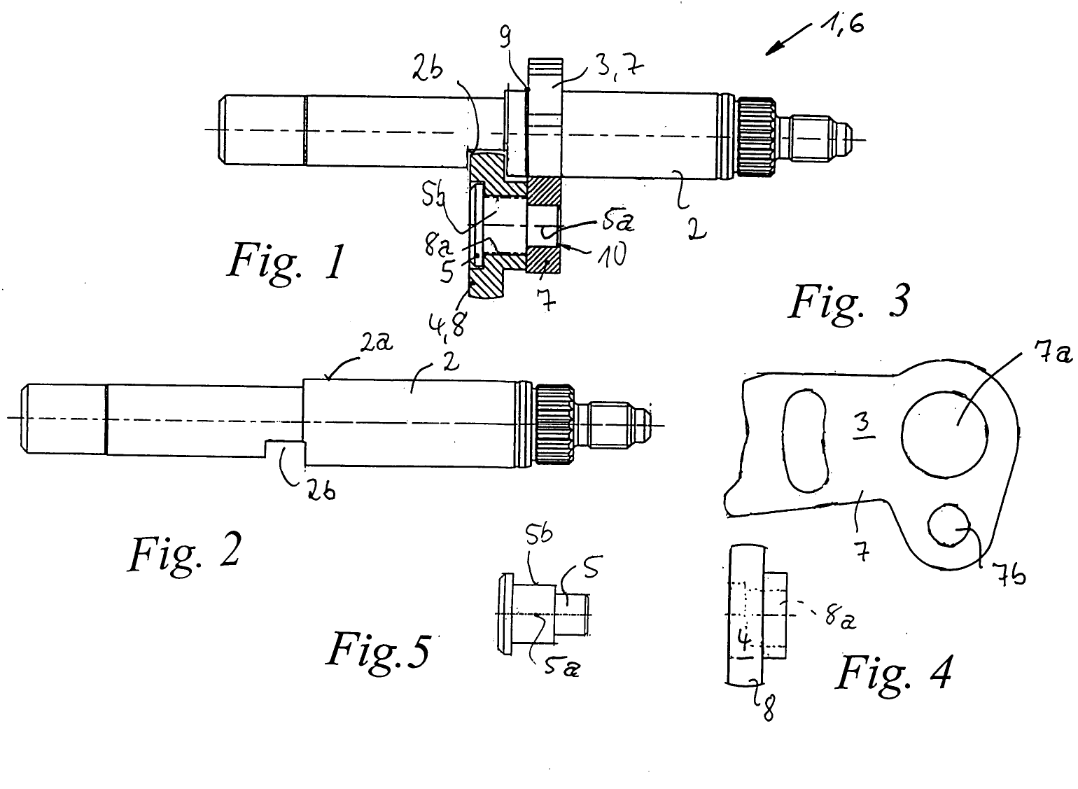

### DESCRIPTION OF A PREFERRED EMBODIMENT OF THE INVENTION

The modular unit 1 has a shaft 2, on which a support 3 in the form of a selector lever 7 is seated. The machine part 4 in the form of a roller 8 is fastened to the selector lever 7 by means of a bolt 5 in such a way that the lever is rotatable about the axis of rotation 5a of the bolt.

FIG. 2 shows the shaft 2 produced by a combination of non-cutting forming methods and cutting machining methods. The support 3 according to FIG. 3 is a stamped part. The machine part 4, configured as a roller 8, is according to FIG. 4 produced in a non-cutting manner by rolling or extruding and optionally subsequently machined in the cylindrical through-hole 8a. The bolt 5 represented in FIG. 5 is an extruded part. All the individual parts of the modular unit 1 are produced from low-carbon case-hardening steel (for example of the material designation 16MnCr5). The individual parts 2, 3, 4, 5 are assembled in the following sequence to form the modular unit 1:

placing of the selector lever 7 with the through-hole 7a onto the snug fit 2a of the shaft 2 and securing it with a laser weld 9;

positioning the roller 8 in the recess 2b and inserting the bolt 5 into the through-hole 8a;

pressing the bolt 5 into the circular through-hole 7b and securing the bolt 5 on the support 3 by means of a laser weld 10.

Following the assembly of the modular unit 1, the complete heat treatment is provided. In this, the modular unit 1 is plasma-nitrided, creating a bonding layer VS of 0.015+0.010 μm. An amount of radial play between the through-hole 8a of the roller 8 and the rotating seating 5b reduces the increase in volume of the components 5 and 4 by about 8 μm to 12 μm and does so to such an extent that the plasma atmosphere required for the heat treatment in the annular gap around the bolt 5 is no longer adequate to add sufficient nitrogen. An amount of radial play of about 0.05 to at most 0.25 μm remains at the rotating seating. After the heat treatment, the modular unit 1 is completely provided with a hard outer layer, to which a corrosion-resistant oxide layer of 1 μm+1 μm is applied in the further heat treatment by means of oxiding.

Although the present invention has been described in relation to a particular embodiment thereof, many other variations and modifications and other uses will become apparent to those skilled in the art. It is preferred, therefore, that the present invention be limited not by the specific disclosure herein, but only by the appended claims.

What is claimed is:

1. A modular unit for use in a gear-shifting mechanism, the modular unit being prefabricated independently of the gear-shifting mechanism, the modular unit comprising:
at least one machine part of an iron material;
at least one support of an iron material for supporting the machine part, the machine part is connected to the support for the machine part to be at least pivotable about an axis of rotation of the machine part and in relation to the support, and
the modular unit having at least partly a hard outer layer produced in a heat treatment of the complete modular unit.

2. The modular unit as claimed in claim 1, wherein the hard outer layer of the modular unit is produced in a thermochemical heat treatment.

3. The modular unit as claimed in claim 2, wherein the hard outer layer has a nitrided layer.

4. The modular unit as claimed in claim 3, wherein the nitrided layer is formed by an iron-bonded nitrogen.

5. The modular unit as claimed in claim 4, wherein the outer layer has in an outward direction an iron oxide layer of the composition Fe₃O₄.

6. The modular unit as claimed in claim 2, wherein the outer layer has in an outward direction an iron oxide layer of the composition Fe₃O₄.

7. The modular unit as claimed in claim 1, wherein the machine part is a roller and a bolt on which the roller is rotatably fastened for rotation around the axis of rotation; and
the roller is connected to the support by the bolt.

8. A method for producing a modular unit for use in a gear shift mechanism, the method comprising the following steps:
producing a support of an iron material, producing a machine part of an iron material;
connecting at least the support and the machine part to form the modular unit, with the support supporting the machine part for pivoting in relation to the support; and
heat treating the complete modular unit.

9. The method as claimed in claim 8, wherein the heat treatment comprises subjecting at least certain portions of the modular unit to a thermochemical heat treatment.

10. The method as claimed in claim 9, wherein the heat treatment comprises subjecting the modular unit to a heat treatment in a nitriding method.

11. The method as claimed in claim 10, wherein the heat treatment comprises subjecting the modular unit to a heat treatment in a plasma nitriding method.

12. The method as claimed in claim 11, wherein following the nitriding method, post-oxidizing the modular unit.

13. The method as claimed in claim 11, wherein following the heat treatment in the nitriding method, at least partially oxidizing the surface of the modular unit.
